(19) United States
(12) Patent Application Publication
(10) Pub. No.: US 2013/0257374 A1
(43) Pub. Date: Oct. 3, 2013

(54) CHARGING DEVICE FOR ELECTRICALLY DRIVEN VEHICLE, AND VEHICLE INCORPORATING THE SAME

(71) Applicant: HONDA MOTOR CO., LTD., TOKYO (JP)

(72) Inventors: Hiroki ICHIKAWA, SAITAMA (JP); Tadashi ONOZUKA, SAITAMA (JP); Kenji TAMAKI, SAITAMA (JP)

(73) Assignee: HONDA MOTOR CO., LTD., TOKYO (JP)

(21) Appl. No.: 13/834,866

(22) Filed: Mar. 15, 2013

(30) Foreign Application Priority Data
Mar. 27, 2012 (JP) 2012-072086

(51) Int. Cl. B60L 11/18

(52) U.S. Cl. CPC B60L 11/1809
USPC 320/109

(57) ABSTRACT

A charging device for an electrically driven motorcycle includes a base member which is mounted on a vehicle body of the electrically driven motorcycle; and a charging member which is mounted on the base member and which includes a charging port operable to be selectively connected with a connector of a charging cable extended from an external charger. The charging member provided with the charging port is mounted on the base member such that a position and a direction of the charging port are selectively changeable with respect to the vehicle body. Such charging device enhances convenience in charging an electrically driven vehicle.

### CROSS-REFERENCE TO RELATED APPLICATIONS

The present invention claims priority under 35 USC 119 based on Japanese patent application No. 2012-072086, filed on Mar. 27, 2012. The entire subject matter of this priority document, including specification claims and drawings thereof, is incorporated by reference herein.

### BACKGROUND OF THE INVENTION

1. Field of the Invention

The present invention relates to a rotatably mounted charging device for charging a battery mounted on an electrically driven vehicle from an external charger via a charging port, and to a vehicle incorporating the same. More particularly, the present invention relates to a charging device which is rotatably mounted on a vehicle body; or to a plurality of charging devices mounted on the vehicle body, each being pivotally movable in longitudinal and lateral directions of the vehicle body, and to a vehicle incorporating the same.

2. Description of the Background Art

There is a known technique where a charging port is mounted inside a storage box. The storage box is formed on a rear surface of an upper portion of a leg shield of an electrically driven vehicle or inside storage space formed below a seat. A connector of a charging cable extended from an external charger is inserted into the charging port in a state where a lid of the storage box or the seat is opened thus charging a battery mounted on the electrically driven vehicle by the external charger via the charging cable, the connector and the charging port. An example of such technique is disclosed in the Japanese Patent 3343361 Publication.

With respect to the position and the direction of a charging port formed in an electrically driven vehicle, there may be a case where the position and the direction enable the easy connection between the charging port and the external charger or a case where the position and the direction make the connection between the external charger and the charging port difficult depending on a parking position of the electrically driven vehicle, the position of the external charger and a distance between the charging port and the external charger.

In the electrically driven vehicle, such as that described in the Japanese Patent 3343361 Publication, the charging port is formed inside the storage box and on a right side of a vehicle body and inside the storage space formed below the seat and on a left side of the vehicle body respectively.

Accordingly, for example, when the external charger is on a right side of the seat and the external charger and the charging port inside the storage space are connected to each other, it is necessary to connect the external charger and the charging port by routing around the charging cable such that the charging cable straddles the vehicle body.

On the other hand, when the external charger is on a left side of the storage box and the external charger and the charging port inside the storage box are connected to each other, it is necessary to connect the external charger and the charging port by routing around the charging cable such that the charging cable straddles the vehicle body.

In this manner, the technique described in the Japanese Patent 3343361 Publication has a drawback that convenience with respect to charging of the electrically driven vehicle is lowered due to the parking position of the electrically driven vehicle, the position of the external charger and the distance between the charging port and the external charger.

The present invention has been made in an effort to overcome the above-mentioned drawbacks of conventional charging device. Accordingly, it is one of the objects of the present invention to provide a charging device which can enhance convenience in charging an electrically driven vehicle.

### SUMMARY OF THE INVENTION

In order to achieve the above objects, the present invention according to a first aspect thereof provides a charging device for an electrically driven vehicle (10). The charging device includes a charging port (110) mounted on a vehicle body (114) of an electrically driven vehicle (10). The charging device according to the first aspect of the present invention is characterized in that the charging port (110) is mounted on the vehicle body such that the direction of the charging port (110) is changeable with respect to the vehicle body (114).

The present invention according to a second aspect thereof, in addition to the first aspect, is characterized in that the charging device further includes a base member (also referred as a base member) (116) mounted on the vehicle body (114), and a charging portion (also referred as a charging member) (112) which is mounted on the base member (116) and includes the charging port (110), and the charging member (112) is mounted on the base member (116) in a pivotally movable manner in the longitudinal direction of the vehicle body (114) and/or in the lateral direction of the vehicle body (114).

The present invention according to a third aspect thereof, in addition to the second aspect, is characterized in that the charging member (112) is mounted such that the direction of the charging member (112) is changeable with respect to the base member (116).

The present invention according to a fourth aspect thereof, in addition to one of the second and third aspects, is characterized in that the base member (116) is mounted on the vehicle body (114) in a pivotally movable manner about an axis which intersects with a mounting surface of the vehicle body (114).

The present invention according to a fifth aspect thereof, in addition to one of the first through third aspects, is characterized in that the charging port (110) is mounted on the vehicle body (114) such that the direction of the charging port (110) with respect to the vehicle body (114) is changeable via a bearing structure (116) mounted on a vehicle body (114) side.

The present invention according to a sixth aspect thereof, in addition to the fifth aspect, is characterized in that the charging port (110) is mounted on an approximately spherical member (112), and the bearing structure (116) is the spherical bearing structure which supports the spherical member (112).

The present invention according to a seventh aspect thereof, in addition to one of the first through sixth aspects, is characterized in that the charging device further includes a restricting member (158, 160) which restricts the position and the direction of the charging port (110).

The present invention according to an eighth aspect thereof, in addition to one of the first through seventh aspects, is characterized in that the charging port (110) is arranged on a center line of the vehicle body (114) along the longitudinal direction of the vehicle body (114) as viewed in a plan view.

### Advantages of the Invention

According to the first aspect of the present invention, the charging port is mounted such that the direction of the charging port is changeable with respect to the vehicle body. Accordingly, by changing the direction of the charging port corresponding to the parking position of the electrically driven vehicle, the position of the external charger and the distance between the charging port and the external charger, a connector of a charging cable extended from the external charger can be easily inserted into the charging port. As a result, the charging port and the external charger can be easily connected to each other thus enhancing the convenience in charging the electrically driven vehicle.

According to the second aspect of the present invention, the charging member including the charging port is mounted on the base member such that the charging member is pivotally movable in the longitudinal direction of the vehicle body and/or in the lateral direction of the vehicle body. Due to such a constitution, the charging port and the connector can be more easily connected to each other thus further enhancing the convenience in charging the electrically driven vehicle.

According to the third aspect of the present invention, the charging member is mounted such that the direction of the charging member is changeable with respect to the base member. Due to such a constitution, even when the base member is fixed to the vehicle body, the charging port and the connector can be easily connected to each other.

According to the fourth aspect of the present invention, by rotating the base member about the axis which intersects with the mounting surface of the vehicle body, the position and the direction of the charging port can be easily changed to a position and a direction which enable the easy connection between the charging port and the connector.

According to the fifth aspect of the present invention, the charging port is mounted on the vehicle body by way of the bearing structure and hence, the direction of the charging port with respect to the vehicle body can be easily changed. It is needless to say that the previously-mentioned base member may have the above-mentioned bearing structure.

According to the sixth aspect of the present invention, by supporting the spherical member on which the charging port is mounted by the spherical bearing structure, the position and the direction of the charging port can be easily changed to the position and the direction which enable the easy connection between the charging port and the connector. It is needless to say that the previously-mentioned charging member constitutes the spherical member, and the base member has the spherical bearing structure.

According to the seventh aspect of the present invention, by restricting the position and the direction of the charging port by the restricting member, it is possible to prevent a cable inside the electrically driven vehicle which connects the charging port and a battery of the electrically driven vehicle to each other from being twisted or cut.

According to the eighth aspect of the present invention, the charging port is arranged on the center line of the vehicle body along the longitudinal direction of the vehicle body as viewed in a plan view and hence, the direction of the charging port can be easily changed to the desired direction which enables the connection between the charging port and the connector corresponding to the parking position of the electrically driven vehicle, the position of the external charger, and the distance between the charging port and the external charger.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a left side view of an electrically driven motorcycle having a charging device mounted thereon.

FIG. 2 is a plan view of the electrically driven motorcycle shown in FIG. 1.

FIG. 3 is a schematic constitutional view of a charging device according to a first embodiment.

FIG. 4 is a perspective view showing the fitting engagement between a charging member of the charging device and a connector shown in FIG. 3.

FIG. 5A is an explanatory view showing a connection state between the charging member and a base member, in which the base member is pushed toward a charging member side by a repulsive force of the spring, and the hill portions are engaged with the groove portions.

FIG. 5B is an explanatory view showing a connection state between the charging member and a base member, in which a user firstly moves the charging member downward while holding the charging member for releasing an engaging state between the hill portions and the groove portions thereby moving the charging member against a repulsive force of the spring.

FIG. 6 is a schematic constitutional view of a charging device according to a second embodiment.

FIG. 7A is a perspective view of the charging device shown in FIG. 6.

FIG. 7B is a plan view of the charging device.

FIG. 8 is a schematic constitutional view of a charging device according to a third embodiment.

FIG. 9 is an explanatory view showing a connection state between a base member and a charging member of the charging device shown in FIG. 8.

FIG. 10 is a schematic constitutional view of a charging device according to a fourth embodiment.

FIG. 11 is an explanatory view showing a lower portion of the charging device shown in FIG. 10 in an enlarged manner.

FIG. 12A is an explanatory view showing a state including the charging port at a specified position where a charging member having an approximately spherical shape is supported on a base member having the spherical bearing structure.

FIG. 12B is an explanatory view showing a state including the charging port at another specified position where a charging member having the approximately spherical shape is supported on the base member having the spherical bearing structure.

### DETAILED DESCRIPTION OF ILLUSTRATIVE EMBODIMENTS

An embodiment of the present invention will now be described, with reference to the drawings. Throughout this description, relative terms like “upper”, “lower”, “above”, “below”, “front”, “back”, and the like are used in reference to a vantage point of an operator of the vehicle, seated on the driver's seat and facing forward. It should be understood that these terms are used for purposes of illustration, and are not intended to limit the invention.

Hereinafter, a charging device of an electrically driven vehicle according to the present invention is explained in detail in conjunction with attached drawings showing illustrative embodiments.

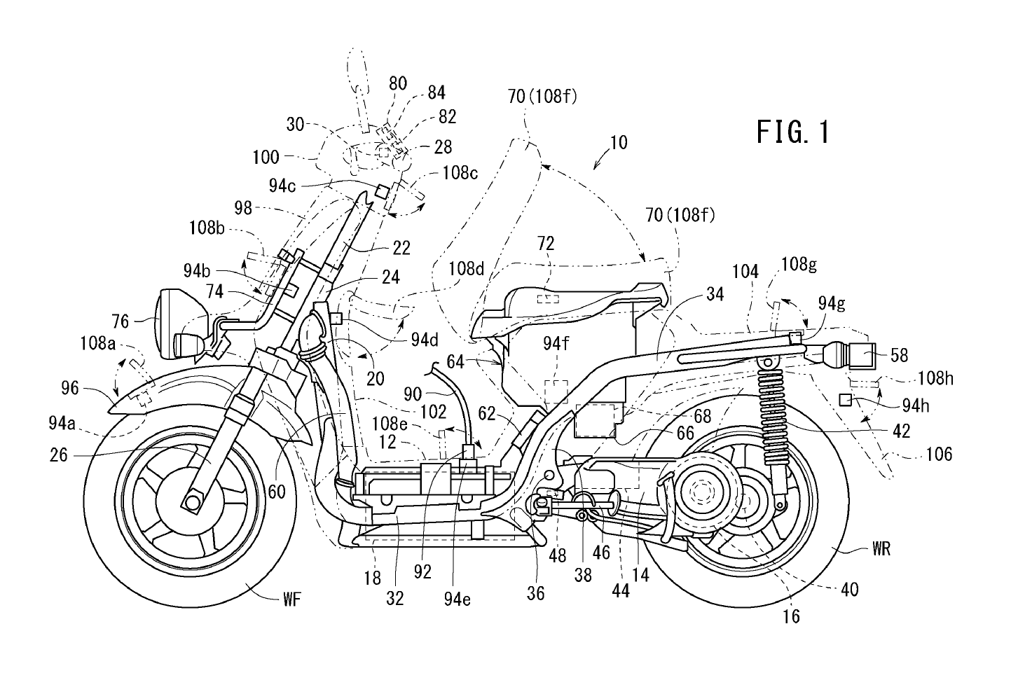

FIG. 1 is a left side view of an electrically driven motorcycle 10 which constitutes an electrically driven vehicle on which a charging device according to an illustrative embodiment of the present invention is mounted.

The electrically driven motorcycle 10 is a scooter-type motorcycle having a step floor 12, wherein a rear wheel WR is driven by a rotary drive force of a motor 16 mounted on a swing arm 14. The motor 16 is, for example, driven by the supply of power from a high-voltage main battery 18 of 72V. The main battery 18 includes a plurality of modules in each of which a plurality of battery cells are connected in series.

A head pipe 24 which pivotally and rotatably supports a steering stem 22 is connected to an upper end portion of a main frame 20. A pair of left and right front forks 26 which pivotally and rotatably support a front wheel WF is mounted on the steering stem 22. The front wheel WF is steerable by a steering handle 28 which is mounted on an upper portion of the steering stem 22 and has an acceleration grip. A throttle sensor 30 which detects a rotational angle of the acceleration grip, that is, the degree of accelerator opening is mounted on the steering handle 28.

A pair of left and right side frames 32 which extend toward a rear side of the vehicle body is connected to the main frame 20, and rear frames 34 which extend to an upper rear side of the vehicle body are connected to the pair of left and right side frames 32. A pivot plate 38 on which a swing arm pivot 36 is formed is mounted on a rear portion of the side frame 32.

A front end portion of the cantilever-type swing arm 14 which supports the rear wheel WR only by an arm on a left side in the vehicle widthwise direction is pivotally supported on the swing arm pivot 36 in a swingable manner. The rear wheel WR is pivotally and rotatably supported on a rear end portion of the swing arm 14 by an axle 40, and the rear end portion of the swing arm 14 is suspended from the rear frame 34 by a rear suspension 42. Further, a tail light 58 is mounted on the rear frame 34.

A Power Drive Unit (PDU) 44 which converts a direct current supplied from the main battery 18 into an alternating current and supplies the alternating current to the motor 16 is mounted on the swing arm 14. A side stand 46 is mounted on the pivot plate 38, and the side stand 46 includes a side stand switch 48 which outputs a detection signal when the side stand 46 is retracted to a predetermined position.

An air introducing pipe 60 is connected to a front portion of the main battery 18, and an air suction fan 62 is mounted on a rear portion of the main battery 18. Air is introduced to the main battery 18 from the air introducing pipe 60 by the air suction fan 62 and is discharged to the rear side of the vehicle body. Due to such a constitution, the main battery 18 heated during operation can be cooled using outside air.

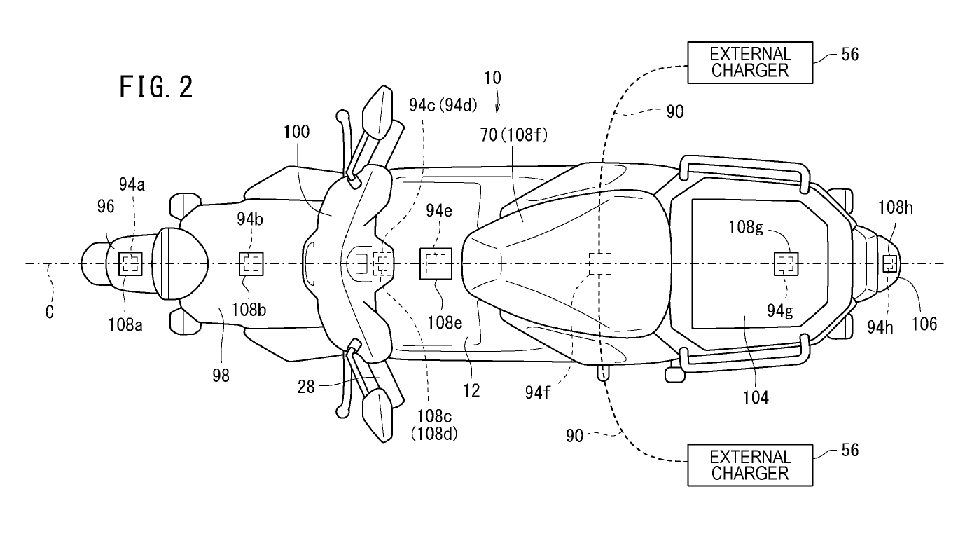

A storage chamber 64 is arranged between the pair of left and right rear frames 34, and a low-voltage (e.g. 12V) sub battery 68 which is charged by the main battery 18 or an external charger 56 shown in FIG. 2 is housed in a storage-chamber bottom portion 66 which projects downward from the storage chamber 64, for example. A rider's seat 70 which also functions as a lid for the storage chamber 64 is arranged above the storage chamber 64, and a seat switch 72 which is operated when the rider sits on the rider's seat 70 and outputs a sitting signal is mounted on the rider's seat 70.

A bracket 74 is joined to a front portion of the head pipe 24. A headlight 76 is mounted on a front end portion of the bracket 74. Further, a meter unit 80 which displays a vehicle speed and the like is arranged in the vicinity of the steering handle 28. The meter unit 80 includes an indicator 82 which prompts the rider to perform deterioration diagnosis of the main battery 18 and a display part 84 which displays a battery residual capacity.

In this embodiment, as shown in FIG. 1 and FIG. 2, a charging device 94a, . . . 94h which is connectable with a connector 92 of a charging cable 90 extended from the external charger 56 is mounted on at least one portion of the electrically driven motorcycle 10. The charging devices 94a to 94h are, as viewed in a plan view shown in FIG. 2, arranged on a center line C which extends along the longitudinal direction of the electrically driven motorcycle 10.

To be more specific, it is sufficient that the charging device 94a, . . . 94h is connected to the connector 92 so that the main battery 18 and the sub battery 68 are charged by the external charger 56 via the charging cable 90 and the connector 92. Accordingly, it is preferable to mount the charging device 94a, . . . 94h on at least one portion in the electrically driven motorcycle 10 out of the following mounting portions (1) to (8). It may be noted that the charging device may be mounted on a plurality of portions.

(1) The charging device 94a is mounted on an upper surface side of a front fender 96 which is mounted on the front fork 26 and covers the front wheel WF from above.

(2) The charging device 94b is mounted on an inner side of a front cover 98 which covers the head pipe 24 from a front side.

(3) The charging device 94c is mounted on an inner side of a handle cover 100 which covers a center portion of the steering handle 28.

(4) The charging device 94d is mounted on an inner side of a leg shield 102 which is continuously formed with the front cover 98 so as to cover legs of the rider seated on the rider's seat 70 from a front side.

(5) The charging device 94e is mounted on an upper surface side of the step floor 12.

(6) The charging device 94f is mounted on a lower portion side in the storage chamber 64.

(7) The charging device 94g is mounted on an upper surface side of a rear cover 104 which covers the rear wheel WR from above.

(8) The charging device 94h is mounted on a rear surface side of a rear fender 106 which is contiguously formed with the rear cover 104 and covers the rear wheel WR from an oblique posterior position.

The charging devices 94a to 94h are, in a non-charged state, are covered with lid portions 108a to 108h. Hence, these charging devices 94a to 94h cannot be visually recognized when viewed from the outside. On the other hand, at the time of charging, the charging device 94a, . . . 94h is exposed to the outside as a rider opens the lid portions 108a, . . . 108h so that the charging device 94a, . . . 94h is brought into a state where the charging device 94a, . . . 94h is connectable with the connector 92. Here, the lid portion 108f also functions as the rider's seat 70.

FIG. 1 shows a case where, the charging device 94e and the connector 92 are connected to each other in a state where the lid portion 108e mounted on the step floor 12 is opened so that the charging device 94e is exposed to the outside, and the main battery 18 and the sub battery 68 are charged by the external charger 56 via the charging cable 90, the connector 92 and the charging device 94e.

Further, FIG. 2 shows a case where the external charger 56 and the charging device 94f are connected to each other by way of the charging cable 90.

In this embodiment, as shown in FIG. 2, the charging devices 94a to 94h are arranged on the center line C. Hence, irrespective of the position and the direction of the external charger 56 with respect to the electrically driven motorcycle 10, the main battery 18 and the sub buttery 68 can be charged by connecting the connector 92 of the charging cable 90 and the charging devices 94a, . . . 94h to each other without routing the charging cable 90 such that the charging cable 90 straddles over the vehicle body of the electrically driven motorcycle 10.

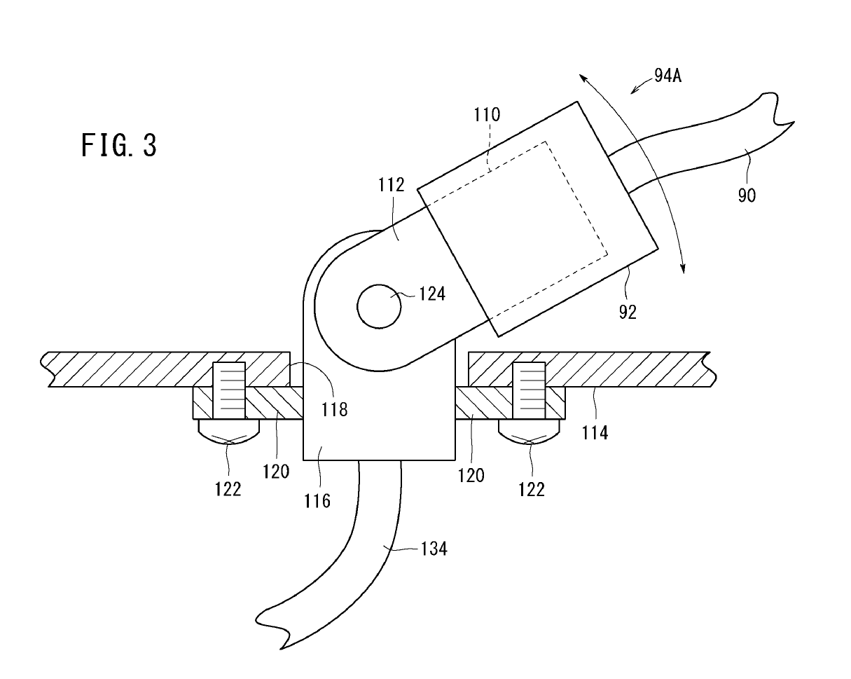

Next, the specific constitutions of the above-mentioned charging devices 94a to 94h are explained in conjunction with FIG. 3 to FIG. 12B.

Here, charging devices 94A to 94D according to the first to fourth embodiments which are applicable to any one of the above-mentioned charging devices 94a to 94h are explained sequentially.

FIG. 3 through FIG. 5B show the charging device 94A according to the first embodiment.

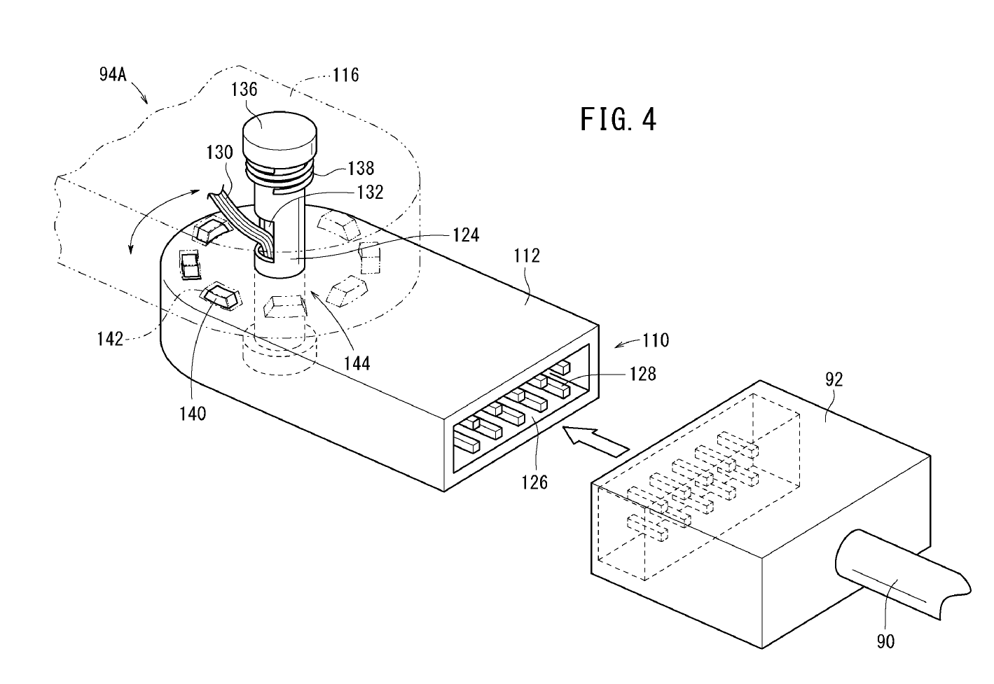

As shown in FIG. 3 and FIG. 4, the charging device 94A includes a charging member 112 provided with a charging port 110 on which the connector 92 is fitted, and a base member 116 which is connected to the charging member 112 and is fixed to a vehicle body 114 of the electrically driven motorcycle 10.

The vehicle body 114 shows the vehicle body of the electrically driven motorcycle 10 which includes: a portion of the front fender 96 on which the charging device 94a shown in FIG. 1 and FIG. 2 is mounted; a portion of the front cover 98 on which the charging device 94b is mounted; a portion of the handle cover 100 on which the charging device 94c is mounted; a portion of the leg shield 102 on which the charging device 94d is mounted; a portion of the step floor 12 on which the charging device 94e is mounted; a portion of the lower portion of the storage chamber 64 on which the charging device 94f is mounted; a portion of the rear cover 104 on which the charging device 94g is mounted; and a portion of the rear fender 106 on which the charging device 94h is mounted.

In the charging device 94A, the base member 116 passes through a hole portion 118 formed on the vehicle body 114, and a flange 120 which projects from a side surface of the base member 116 and the vehicle body 114 are fastened to each other using bolts 122 so that the base member 116 is fixed to the vehicle body 114. The charging member 112 is rotatably mounted on a distal end side of the base member 116 about a shaft portion 124.

Further, the lateral direction in FIG. 3 may be either the longitudinal direction of the electrically driven motorcycle 10 along the center line C in FIG. 2 or the lateral direction of the electrically driven motorcycle 10 which intersects with the center line C. Accordingly, in the charging device 94A, the charging member 112 provided with the charging port 110 is pivotally movable in the longitudinal direction or in the lateral direction of the electrically driven motorcycle 10 with respect to the vehicle body 114 and the base member 116 about the shaft portion 124.

As shown in FIG. 4, for example, a recessed portion 126 is formed in the charging member 112 at a position where the recessed portion 126 faces the connector 92, and a plurality of pins 128 are arranged in the recessed portion 126 thus forming the charging port 110 of a male-type connector. On the other hand, the connector 92 is constituted as a female-type connector which can receive the respective pins 128 when the connector 92 is inserted into the charging port 110.

The shaft portion 124 which penetrates the charging member 112 and the base member 116 and pivotally supports the charging member 112 on the base member 116 has a portion thereof formed into a hollow cylindrical shape, and a plurality of cables 130 which are connected to the respective pins 128 are led to the base member 116 through an opening portion 132 communicated with the hollow cylindrical portion. The cables 130 are tied in a bundle as a harness 134, and the harness 134 connects the base member 116, the main battery 18 and the sub battery 68 to each other.

A spring 138 which applies a biasing force toward the base member 116 is interposed between one end portion 136 of the shaft portion 124 on the base member 116 side and the base member 116. Further, projecting hill portions 140 are formed on a contact surface of the charging member 112 which is in contact with the base member 116 at predetermined angular intervals about the shaft portion 124, while groove portions 142 which are engageable with the projecting hill portions 140 are formed on a contact surface of the base member 116 which is in contact with the charging member 112 at predetermined angular intervals about the shaft portion 124. The shaft portion 124, the spring 138, the plurality of hill portions 140 and the plurality of groove portions 142 constitute a ratchet mechanism 144 for rotating the charging member 112 about the shaft portion 124 by a predetermined angle with respect to the vehicle body 114 and the base member 116.

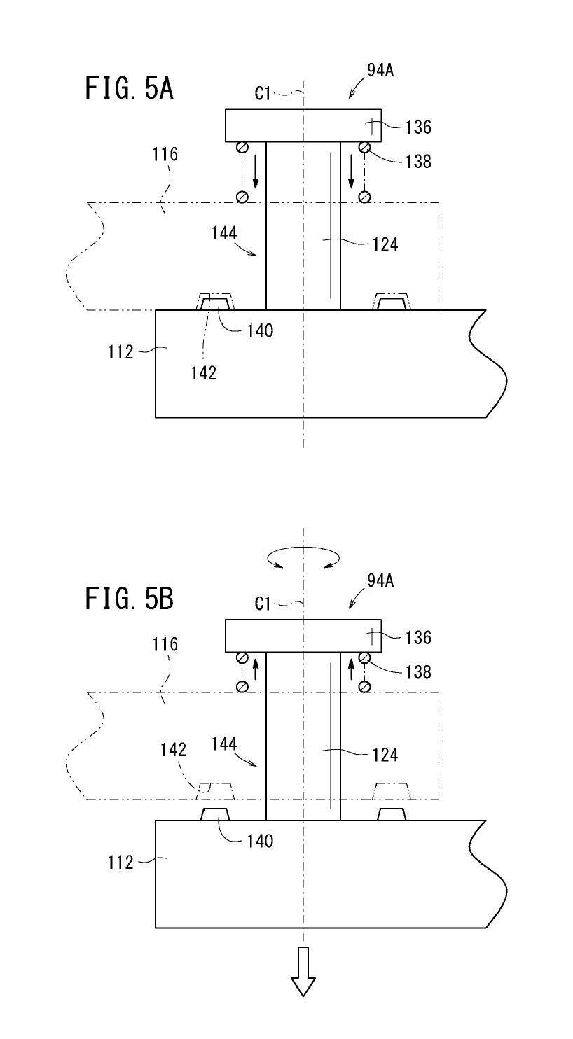

Accordingly, as shown in FIG. 5A, usually, the base member 116 is pushed toward a charging member 112 side by a repulsive force of the spring 138, and the hill portions 140 are engaged with the groove portions 142.

The charging device the electrically driven motorcycle 10 according to the first embodiment, discussed above, may be charged by the external charger 56 as follows.

Depending on a parking position of the electrically driven motorcycle 10 in a parking space such as a garage of a courier, a position of the external charger 56 in the parking space with respect to the electrically driven motorcycle 10 parked at the parking position, and a distance between the charging port 110 and the external charger 56, it is necessary to change the position and the direction of the charging port 110 with respect to the vehicle body 114 to the desired position and direction which facilitate the insertion of the connector 92 into the charging port 110. Further, in inserting the connector 92 into the charging port 110, it is desirable that the charging cable 90 is routed around in such a manner that the charging cable 90 does not straddle over the vehicle body 114 of the electrically driven motorcycle 10.

Accordingly, a user such as a rider of the electrically driven motorcycle 10 firstly moves the charging member 112 downward as shown in FIG. 5B in a state where the user holds the charging member 112. Due to such an operation, the user can release an engaging state between the hill portions 140 and the groove portions 142 by moving the charging member 112 against a repulsive force of the spring 138.

Next, in such a released state, the user rotates the charging member 112 about a center axis C1 of the shaft portion 124 to a predetermined angle which corresponds to the desired position and direction which facilitate the insertion of the connector 92 into the charging port 110 and, thereafter, releases his hand from the charging member 112. Due to such an operation, the spring 138 is released from a compressed state brought about by holding of the charging member 112 by the user. Hence, the base member 116 is moved toward the charging member 112 by a repulsive force of the spring 138. As a result, the hill portions 140 and the groove portions 142 are engaged with each other, and the charging member 112 is brought into a state shown in FIG. 5A and is fixed at a predetermined angle.

Next, the user inserts the connector 92 into the charging port 110 of the charging member 112 which is adjusted to the predetermined angle. In this case, the charging port 110 is fixed to a predetermined angle which corresponds to the desired position and direction and hence, the user can easily insert the connector 92 into the charging port 110. Further, the charging port 110 is fixed to the predetermined angle by the ratchet mechanism 144. Hence, it is possible to prevent the charging member 112 from being inadvertently rotated at the time of inserting the connector 92 into the charging port 110.

As a result, the main battery 18 and the sub battery 68 can be charged by the external charger 56 via the charging cable 90, the connector 92, the charging member 112, the respective cables 130 and the harness 134.

The charging device 94a, . . . 94h which adopts the charging device 94A is covered with the lid portion 108a, . . . 108h in a non-charging state. Hence, the user may perform the above-mentioned operation after opening the lid portion 108a, . . . 108h. Further, as described previously, the lateral direction in FIG. 3 corresponds to the longitudinal direction or the lateral direction of the electrically driven motorcycle 10. Hence, in the charging device 94A, the charging port 110 can be easily changed to a predetermined angle along the longitudinal direction or the lateral direction of the electrically driven motorcycle 10 with respect to the vehicle body 114 and the base member 116.

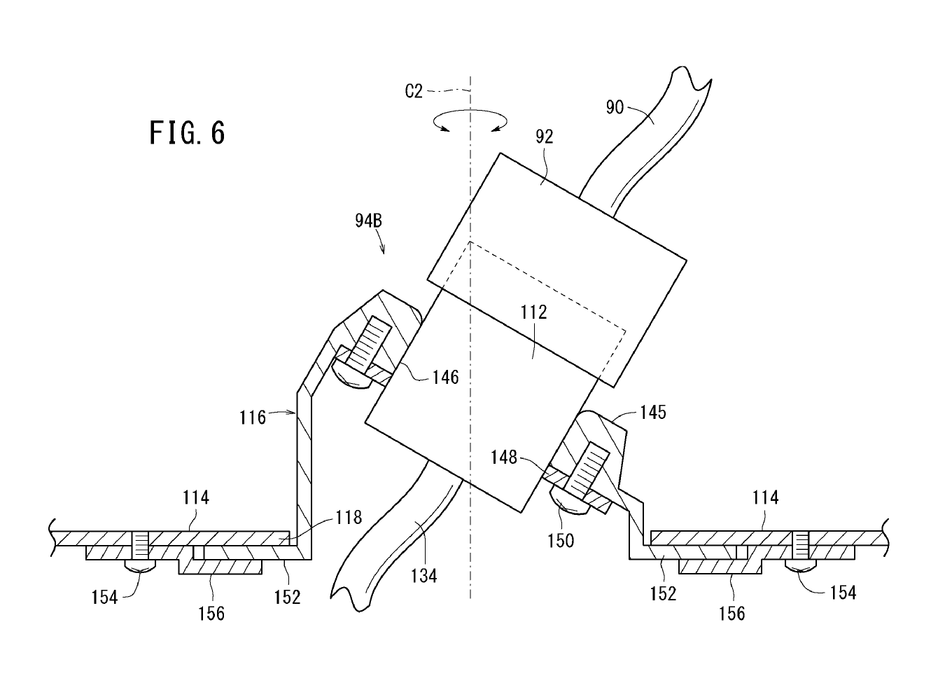

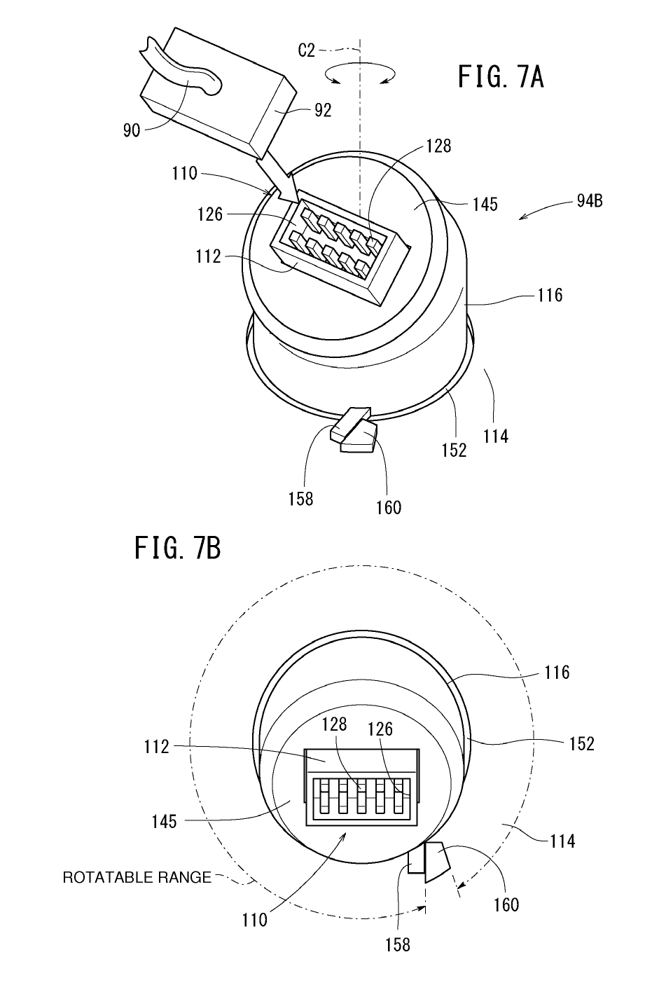

FIG. 6 to FIG. 7B show a charging device 94B according to the second embodiment. Here, with respect to constitutional elements identical with the constitutional elements in the first embodiment explained in conjunction with FIG. 3 to FIG. 5B, the detailed explanation of these parts is omitted although these parts are given the same symbols/reference numerals. The same goes for other embodiments explained hereinafter.

In the charging device 94B, a charging member 112 is fixed to a base member 116, and the charging member 112 and the base member 116 are integrally pivotally movable with respect to a vehicle body 114 about a center axis C2 of the base member 116.

More specifically, the base member 116 is formed of an approximately cylindrical member which has an inclined upper portion. The charging member 112 passes through a hole portion 146 formed in an inclined surface 145 of the base member 116, and a flange 148 which projects from a side surface of the charging member 112 and an upper portion of the base member 116 are fastened to each other using bolts 150 so that the charging member 112 is fixed to the base member 116.

A flange 152 which projects from a lower end portion of the base member 116 is inserted into a gap formed between a support member 156 having an approximately Z shape in cross section which is fastened to the vehicle body 114 by bolts 154 and a bottom surface of the vehicle body 114. Accordingly, the base member 116 can be rotated about the center axis C2 of the base member 116 in a state where the base member 116 is supported on the vehicle body 114 and the support member 156.

In other words, when the lateral direction in FIG. 6 is the longitudinal direction or the lateral direction of the electrically driven motorcycle 10, the charging member 112 and the base member 116 of the charging device 94B are pivotally movable in the longitudinal direction or the lateral direction of the electrically driven motorcycle 10 with respect to the vehicle body 114 about the center axis C2.

Further, as shown in FIG. 7A and FIG. 7B, a projecting portion 158 is formed in a projecting manner from a side surface of the base member 116 to an upper surface of the vehicle body 114, while a projecting portion 160 is formed on a portion of the vehicle body 114 in a projecting manner toward the base member 116 in the vicinity of the hole portion 118. As described previously, the charging member 112 and the base member 116 are pivotally movable about the center axis C2. With the provision of two projecting portions 158, 160, a pivotally movable range of the charging member 112 and the base member 116 is limited to an angular range starting from a right side surface of the projecting portion 160 to a left side surface of the projecting portion 160 in the counterclockwise rotating direction around the base member 116 in FIG. 7B.

In other words, an angular range from an angle at which the projecting portion 158 of the base member 116 is brought into contact with the right side surface of the projecting portion 160 of the vehicle body 114 to an angle at which the projecting portion 158 is brought into contact with the left side surface of the projecting portion 160 is a pivotally movable range of the charging member 112 and the base member 116.

Accordingly, the projecting portions 158, 160 function as limiting portions which limit the pivotally movable range of the charging member 112 and the base member 116.

The charging device the electrically driven motorcycle 10 according to the second embodiment, discussed above, may be charged by the external charger 56 as follows.

A user rotates the charging member 112 and the base member 116 to a predetermined angle within the pivotally movable range about the center axis C2 while holding the charging member 112 and the base member 116. In this case, the predetermined angle is an angle which corresponds to the position and the direction of the charging port 110 with respect to the vehicle body 114 which facilitates the insertion of the connector 92 into the charging port 110.

Due to such an operation, the user can easily insert the connector 92 into the charging port 110 of the charging member 112 which is adjusted to the predetermined angle and hence, the main battery 18 and the sub battery 68 can be charged by the external charger 56 via the charging cable 90, the connector 92, the charging member 112 and the harness 134.

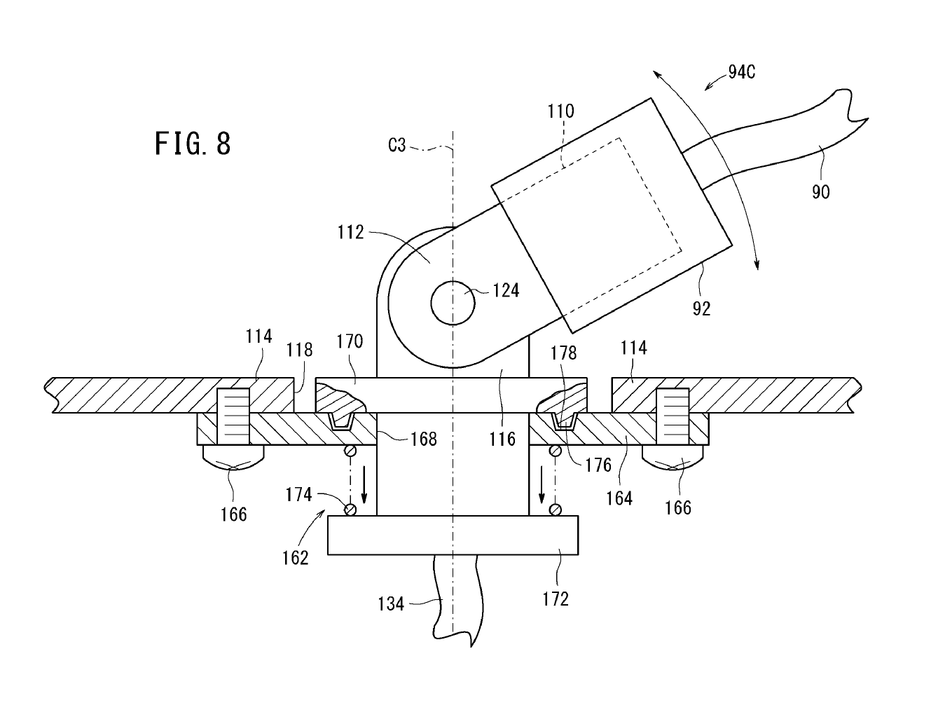

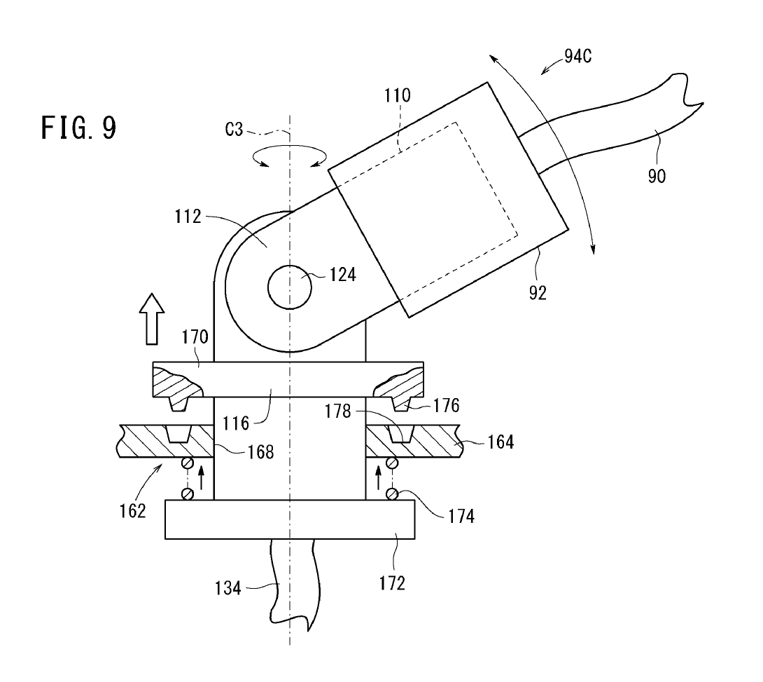

FIG. 8 and FIG. 9 show a charging device 94C according to a third embodiment.

In the charging device 94C, a charging member 112 and a base member 116 are connected to each other by the ratchet mechanism 144 including the shaft portion 124 shown in FIG. 4 to FIG. 5B. Further, a ratchet mechanism 162 having the substantially same constitution as the ratchet mechanism 144 is arranged between the base member 116 and a vehicle body 114. Due to such a constitution, the charging member 112 and the base member 116 are integrally pivotally movable with respect to the vehicle body 114 about a center axis C3 of the base member 116.

In other words, when the lateral direction in FIG. 8 is the longitudinal direction or the lateral direction of the electrically driven motorcycle 10, the charging member 112 and the base member 116 of the charging device 94C are pivotally movable in the longitudinal direction or in the lateral direction of the electrically driven motorcycle 10 with respect to the vehicle body 114 about the center axis C3. Further, the charging member 112 is pivotally movable in the longitudinal direction or in the lateral direction of the electrically driven motorcycle 10 with respect to the base member 116 about the shaft portion 124.

More specifically, a support member 164 is fastened to the vehicle body 114 using bolts 166 in the vicinity of a hole portion 118 of the vehicle body 114. The cylindrical base member 116 passes through a hole portion 168 which is formed in the support member 164 and the hole portion 118. In this case, a flange 170 which projects from a center portion of a side surface of the base member 116 is supported on an upper surface of the support member 164. Between a flange 172 which projects from a lower end portion of the base member 116 and a bottom surface of the support member 164, a spring 174 which is mounted on the base member 116 and applies a biasing force to the flange 172 is interposed.

Further, projecting hill portions 176 are formed on a bottom surface of the flange 170 at predetermined angular intervals about the center axis C3, and a plurality of groove portions 178 which are engaged with the hill portions 176 are formed on an upper surface of the support member 164 at predetermined angular intervals about the center axis C3.

Accordingly, the spring 174, the plurality of hill portions 176 and the plurality of groove portions 178 constitute the ratchet mechanism 162 for rotating the charging member 112 and the base member 116 by a predetermined angle with respect to the vehicle body 114. In this case, also as shown in FIG. 8, usually, the flange 170 is pushed to the support member 164 by a repulsive force of the spring 174 so that the hill portions 176 are engaged with the groove portions 178.

The charging device the electrically driven motorcycle 10 according to the third embodiment, discussed above, may be charged by the external charger 56 as follows.

A user firstly moves the base member 116 upward in FIG. 9 while holding the base member 116. In this case, the base member 116 moves upward against a repulsive force of the spring 174 and hence, the engaging state between the hill portions 176 and the groove portions 178 can be released.

Next, in such a released state, the user rotates the base member 116 to a predetermined angle about the center axis C3 of the base member 116 and, thereafter, releases his hand from the base member 116. Due to such an operation, the spring 174 is released from a compressed state brought about by holding of the base member 116 by the user and hence, the spring 174 can move the base member 116 downward by a repulsive force thereof.

As a result, the hill portions 176 and the groove portions 178 are engaged with each other, and the base member 116 is brought into a state shown in FIG. 8 so that the base member 116 is fixed to the vehicle body 114 at a predetermined angle. Here, the predetermined angle is an angle which corresponds to the position and the direction of the charging port 110 with respect to the vehicle body 114 which facilitate the insertion of the connector 92 into the charging port 110.

Next, the user adjusts the charging member 112 at a predetermined angle with respect to the base member 116 using the method explained in conjunction with the first embodiment.

By performing the adjustment of an angle of the charging member 112 and the base member 116 in such a manner, the user can easily insert the connector 92 into the charging port 110 of the charging member 112. Further, the charging member 112 and the base member 116 are fixed at a predetermined angle by the ratchet mechanisms 144, 162 and hence, the charging port 110 can be fixed at a desired position and in the desired direction.

As a result, it is possible to prevent the charging member 112 and the base member 116 from being inadvertently rotated at the time of inserting the connector 92 into the charging port 110. Accordingly, the main battery 18 and the sub battery 68 can be charged by the external charger 56 via the charging cable 90, the connector 92, the charging member 112, the respective cables 130 and the harness 134.

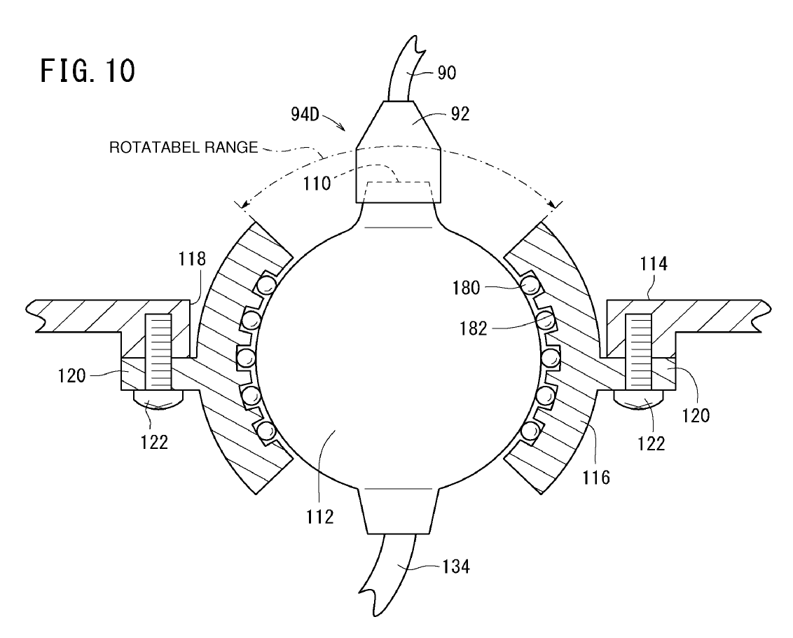

FIG. 10 to FIG. 12B show a charging device 94D according to the fourth embodiment.

In the charging device 94D, a charging member 112 is formed of an approximately spherical body, and a base member 116 is constituted as the spherical bearing structure which supports the spherical charging member 112. In this case, the base member 116 is formed into an arcuate shape such that the base member 116 supports a side surface of the spherical charging member 112 by way of a plurality of balls 180, and the respective balls 180 are housed in recessed portions 182.

Accordingly, as shown in FIG. 10, an angular range between an upper end portion of a right-side arcuate portion and an upper end portion of a left-side arcuate portion of the base member 116 becomes a pivotally movable range where the position and the direction of a charging port 110 are adjustable. In other words, when the lateral direction in FIG. 10 is the longitudinal direction and the lateral direction of an electrically driven motorcycle 10, the charging member 112 of the charging device 94D is pivotally movable in the longitudinal direction and the lateral direction of the electrically driven motorcycle 10 with respect to a vehicle body 114 and the base member 116 within the above-mentioned pivotally movable range.

However, in the fourth embodiment, the base member 116 is constituted as the spherical bearing structure which supports the spherical charging member 112 by the plurality of balls 180. Hence, when a frictional force between the charging member 112 and the balls 180 is small, even when the position and the direction of the charging member 112 including the charging port 110 are adjusted to the desired position and direction which facilitate the insertion of a connector 92, the spherical body is rotated by slippage of the balls 180 thus giving rise to a possibility that the position and the direction of the charging port 110 are moved.

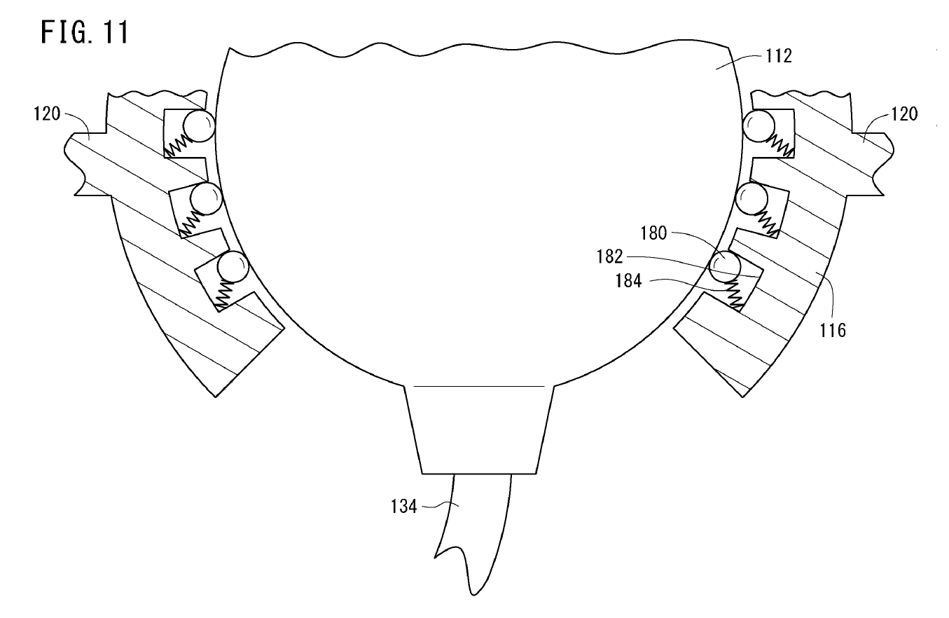

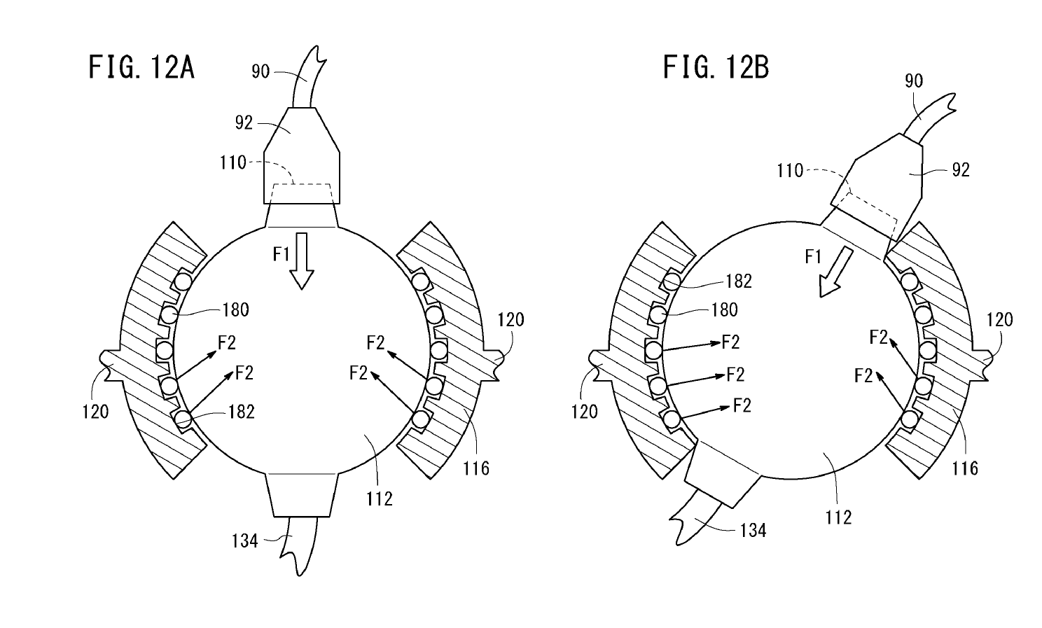

Accordingly, in the fourth embodiment, the provision shown in FIG. 11 to FIG. 12B is provided for surely holding the position and the direction of the charging port 110 adjusted once.

In other words, as shown in FIG. 11, with respect to the balls 180 arranged on a lower side from a center portion in FIG. 10, a size of the respective recessed portions 182 which house these balls 180 therein is set larger than a size of the recessed portions 182 which house the balls 180 on an upper side. Further, the ball 180 on a lower side is fixed to the base member 116 by way of a spring 184. Accordingly, in the recessed portion 182 on a lower side which has a large cross-sectional area, a space which allows the spring 184 to be interposed between the ball 180 on a lower side and the base member 116 is ensured.

In FIG. 10, FIG. 12A and FIG. 12B, in view of the relationship that the whole charging device 94D is illustrated, the illustration of the spring 184 is omitted, and all recessed portions 182 are illustrated as having the same size.

The charging device the electrically driven motorcycle 10 according to the fourth embodiment, discussed above, may be charged by the external charger 56 as follows.

A user firstly adjusts the position and the direction of the charging port 110 to the desired position and the desired direction for the insertion of the connector 92 while holding the charging member 112 and, thereafter, inserts the connector 92 into the charging port 110 after the adjustment.

Accordingly, as shown in FIG. 12A and FIG. 12B, assuming a force which acts on the charging member 112 from the connector 92 when the connector 92 is inserted into the charging port 110 as F1, the balls 180 on a lower side receive the force F1, and are pushed downward in the recessed portions 182 on a lower side by way of the springs 184, and the balls 180 are brought into contact with a wall portion of the base member 116 which forms the recessed portions 182 on a lower side thereon by way of the springs 184.

As a result, a reaction force F2 against the force F1 acts on the charging member 112 from the balls 180 on a lower side in the direction toward the connector 92 and the charging port 110. Accordingly, the charging member 112 including the charging port 110 can hold the above-mentioned desired position and direction by taking a balance between the force F1 and the reaction force F2.

In other words, in the fourth embodiment, even when the position and the direction of the charging port 110 differ between a case shown in FIG. 12A and a case shown in FIG. 12B, the desired position and direction obtained by adjustment can be maintained due to the balance between the force F1 and the reaction force F2 and hence, a main battery 18 and a sub battery 68 are charged by the external charger 56 via the charging cable 90, the connector 92, the charging member 112 and the harness 134 can be surely performed.

As has been explained heretofore, according to the charging device 94a to 94h, 94A to 94D for the electrically driven motorcycle 10 of this embodiment, the charging member 112 including the charging port 110 is mounted such that the position and the direction of the charging member 112 is changeable with respect to the vehicle body 114.

Accordingly, by changing the position and the direction of the charging port 110 corresponding to the parking position of the electrically driven motorcycle 10, the position of the external charger 56 and the distance between the charging port 110 and the external charger 56, the connector 92 of the charging cable 90 extended from the external charger 56 can be easily inserted into the charging port 110. As a result, the charging port 110 and the external charger 56 can be easily connected to each other thus enhancing the convenience in charging the electrically driven motorcycle 10.

Further, the charging member 112 including the charging port 110 is mounted rotatably in the longitudinal direction and/or in the lateral direction of the vehicle body 114 of the electrically driven motorcycle 10 with respect to the base member 116. Hence, the charging port 110 and the connector 92 can be more easily connected to each other thus further enhancing the convenience in charging the electrically driven motorcycle 10. In other words, in this embodiment, the position and the direction of the charging port 110 can be freely changed and hence, the connector 92 can be inserted into the charging port 110 from any angle with respect to the electrically driven motorcycle 10 thus enhancing the layout of the arrangement of the external charger 56.

More specifically, even when the base member 116 is affixed to the vehicle body 114 as described in connection with the first embodiment, provided that the charging member 112 is mounted such that the position and the direction of the charging member 112 are changeable with respect to the base member 116, the charging port 110 and the connector 92 can be easily connected to each other.

Further, as in the case of the second and the third embodiments, by rotating the base member 116 about the center axis C2, C3 which intersects with the vehicle body 114, the position and the direction of the charging port 110 can be changed to the position and the direction which enable the easy connection between the charging port 110 and the connector 92. As a result, the degree of freedom in the direction of taking out the charging cable 90 from the electrically driven motorcycle 10 (the degree of freedom in routing around the charging cable 90) after inserting the connector 92 into the charging port 110 can be enhanced.

Further, by limiting adjustment ranges of the position and the direction of the charging port 110 by restricting a pivotally movable range of the charging member 112 and the base member 116 by the projecting portions 158, 160, it is possible to prevent the cable 130 and the harness 134 which connect the charging port 110 and the main battery 18 and the sub battery 68 of the electrically driven motorcycle 10 from being twisted or cut.

Further, as described in the fourth embodiment, the spherical charging member 112 including the charging port 110 is mounted on the vehicle body 114 by way of the base member 116 having the spherical bearing structure and hence, the position and the direction of the charging port 110 with respect to the vehicle body 114 can be easily changed to the position and the direction which enable the easy connection between the charging port 110 and the connector 92. As a result, the degree of freedom in mounting the connector 92 on the charging port 110 can be further enhanced.

Further, as shown in FIG. 2, the charging device 94a, . . . 94h is arranged on the center line C along the longitudinal direction of the electrically driven motorcycle 10. Accordingly, the position and the direction of the charging port 110 can be easily changed to the desired position and the direction which enable the connection between the charging port 110 and the connector 92 corresponding to the parking position of the motorcycle 10, the position of the external charger 56 and the distance between the charging port 110 and the external charger 56.

By moving the charging port 110 in this manner, the charging cable 90 can be routed around without straddling the electrically driven motorcycle 10 and hence, the connector 92 can be inserted into the charging port 110 from any angle. As a result, the degree of freedom in routing around the charging cable 90 can be further enhanced.

Although the explanation has been made with respect to the case where the charging device 94a, . . . 94h, 94A to 94D is mounted on the electrically driven motorcycle 10 in the above-mentioned embodiments, the present invention is not limited to the above-mentioned explanation. For example, the present invention is also applicable to an electrically driven three-wheeled vehicle and an electrically driven automobile, and the present invention is also applicable to any other vehicle which is chargeable by the external charger 56 via the charging cable 90 and the connector 92.

Although the present invention has been explained in conjunction with the illustrative embodiments, the technical scope of the present invention is not limited to the scope described in the illustrated embodiments. It is apparent for those who are skilled in the art that various modifications or improvements can be added to the above-mentioned embodiments. Modes which are produced by adding such modifications or improvements also fall within the technical scope of the present invention.

What is claimed is:

1. A charging device for an electrically driven vehicle comprising a vehicle body; said charging device comprising a charging port mounted on said vehicle body of the electrically driven vehicle;
wherein said charging port is mounted on said vehicle body in a manner such that a direction of the charging port is adjustably changeable with respect to the vehicle body.

2. The charging device for an electrically driven vehicle according to claim 1, further comprising:
a base member mounted on the vehicle body; and
a charging member mounted on the base member and comprising said charging port;
wherein the charging member is mounted on the base member in a manner such that said charging member is pivotally movable in at least one of a longitudinal direction of the vehicle body, a lateral direction of the vehicle body, and both of the longitudinal and lateral directions of the vehicle body.

3. The charging device for an electrically driven vehicle according to claim 2, wherein
the charging member is mounted such that the direction of the charging member is changeable with respect to the base member.

4. The charging device for an electrically driven vehicle according to claim 2, wherein the base member is mounted on the vehicle body in a pivotally movable manner about an axis which intersects a surface of the vehicle body on which the base member is mounted.

5. The charging device for an electrically driven vehicle according to claim 3, wherein the base member is mounted on the vehicle body in a pivotally movable manner about an axis which intersects a surface of the vehicle body on which the base member is mounted.

6. The charging device for an electrically driven vehicle according to claim 1, further comprising a bearing structure;
wherein the charging port is mounted on the bearing structure such that the direction of the charging port with respect to the vehicle body is changeable via said bearing structure mounted thereon.

7. The charging device for an electrically driven vehicle according to claim 2, wherein said base member comprises a bearing structure;
wherein the charging member is mounted on the bearing structure such that the direction of the charging member with respect to the vehicle body is changeable via said bearing structure mounted thereon.

8. The charging device for an electrically driven vehicle according to claim 3, wherein said base member comprises a bearing structure;
wherein the charging member is mounted on the bearing structure such that the direction of the charging member with respect to the vehicle body is changeable via said bearing structure mounted thereon.

9. The charging device for an electrically driven vehicle according to claim 6, further comprising a spherical member;
wherein the charging member is operatively mounted on said spherical member, and the bearing structure is a spherical bearing structure which supports the spherical member.

10. The charging device for an electrically driven vehicle according to claim 1, further comprising a restricting member which restricts movement of the charging port to limit the position and the direction of the charging port.

11. The charging device for an electrically driven vehicle according to claim 2, further comprising a restricting member which restricts movement of the charging port to limit the position and the direction of the charging port.

12. The charging device for an electrically driven vehicle according to claim 3, further comprising a restricting member which restricts movement of the charging port to limit the position and the direction of the charging port.

13. The charging device for an electrically driven vehicle according to claim 4, further comprising a restricting member which restricts movement of the charging port to limit the position and the direction of the charging port.

14. The charging device for an electrically driven vehicle according to claim 1, wherein the charging port is arranged on a center line of the vehicle body along a longitudinal direction of the vehicle body, as viewed in a top plan view.

15. The charging device for an electrically driven vehicle according to claim 2, wherein the charging port is arranged on a center line of the vehicle body along a longitudinal direction of the vehicle body, as viewed in a top plan view.

16. The charging device for an electrically driven vehicle according to claim 3, wherein the charging port is arranged on a center line of the vehicle body along a longitudinal direction of the vehicle body, as viewed in a top plan view.

17. A charging device for an electric motorcycle having a frame assembly, said charging device comprising
a base member mounted on said frame assembly; and
a charging member having a charging port, said charging member being rotatably mounted on the base member;
wherein the charging member is mounted on the base member such that said charging member is pivotally movable in one of a longitudinal direction of the vehicle body, a lateral direction of the vehicle body, and the longitudinal and lateral directions of the vehicle body.

18. A charging device for an electric motorcycle according to claim 17, wherein the charging port is arranged on a center line of the vehicle body along the longitudinal direction of the vehicle body, as viewed in a plan view; and wherein said charging port is operatively connected with a battery supported by the frame assembly.

19. An electric vehicle comprising
a vehicle body;
a battery supported by the vehicle body; and
a plurality of charging devices arranged in a spaced manner on a center line of the vehicle body along a longitudinal direction of the vehicle body, as viewed in a plan view;
wherein each of said plurality of charging devices comprises
a base member mounted on said frame assembly; and
a charging member having a charging port, said charging member being rotatably mounted on the base member; and
wherein each of the charging devices is electrically connected with said battery.

20. An electric vehicle according to claim 19, wherein each of said charging devices comprises a restricting member which restricts a position and a direction of the charging port.
